(19) United States
(12) Patent Application Publication
(10) Pub. No.: US 2022/0295250 A1
(43) Pub. Date: Sep. 15, 2022

(54) System and Method for Paging and Monitoring a Server

(71) Applicant: James Hobbs, Hobe Sound, FL (US)

(72) Inventor: James Hobbs, Hobe Sound, FL (US)

(21) Appl. No.: 17/196,019

(22) Filed: Mar. 9, 2021

(51) Int. Cl. H04W 4/80; H04W 68/00

(52) U.S. Cl. CPC H04W 4/80; H04W 68/005; H04W 84/18

(57) ABSTRACT

A system and method for paging and monitoring a server in a service establishment. Multiple customer transmitter devices position on tables, and responds to tactile engagement from customers. Tapping, for example, initiates transmission of customer paging signals to a wearable receiver device worn by a server. The customer transmitter device has an elegant design and is easy to operate for technically challenged customers. Further, a service transmission device in a service area of the establishment enables staff to page the server in the same manner. The wearable receiver device includes an OLED display screen that displays the paging signals in sequential order of receiving them. A Z-wave network ties the communication devices together in the service establishment. A processor communicates with a position tracker and a timer integrated in the wearable receiver. The processor calculates time and location of the server in relation to customers, generating a corresponding server report.

### FIELD OF THE INVENTION

The present invention relates generally to a system and method for paging and monitoring a server. More so, the present invention relates to a system for paging a server in a service establishment through use of customer transmitter devices positioned on tables, service transmitter device positioned in a kitchen or service desk, and wearable server devices worn by servers; whereby all the devices are operatively connected through a Z-wave communication protocol.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, Command systems for commercial building and residential automation functions are available using a range of technologies. Among numerous technologies currently in use are X10®, Z-Wave® and Zigbee® technologies. Z-Wave technology is supported by a consortium of users and product developers, who have promulgated a set of Z-Wave communication standards that available through Zensys and the Z-Wave Alliance.

It is known in the art that Z-Wave is based on a mesh network topology. This means each (non-battery) device installed in the network becomes a signal repeater. Z-Wave is a wireless home automation protocol that operates in the 908.42 MHz frequency band. One of the features of Z-Wave is that it utilizes a type of network known as a “mesh network,” which means that one Z-Wave device will pass a data frame along to another Z-Wave device in the network until the data frame reaches a destination device. As a result, Z-Wave signals easily travel through most walls, floors and ceilings, the devices can also intelligently route themselves around obstacles to attain seamless, robust coverage.

Generally, Z-Wave has a range of 100 meters or 28 feet in open air, building materials reduce that range, it is recommended to have a Z-Wave device roughly every 30 feet, or closer for maximum efficiency. The Z-Wave signal can hop roughly 600 feet, and Z-Wave networks can be linked together for even larger deployments. Each Z-Wave network can support up to 232 Z-Wave devices provides the flexibility to add as many devices to the network.

Often, the Z-Wave network comprises a primary hub controller and at least one controllable device, known as a slave node, or more simply, a “node.” The controller establishes the Z-Wave network. The controller is the only device in a Z-Wave network that determines which Z-Wave nodes belong to the network. The primary hub controller is used to add or remove nodes from the network. The process of adding or removing nodes, also known as inclusion/exclusion, requires that the controller must be within direct radio frequency (RF) range of the node that is to be added or deleted from the network.

The user must interact with the controller and the device during this process. For example, to start the process, the controller and the device should be brought together in close physical proximity. Next, the controller is placed in an inclusion mode. Then the device is activated so that it will enroll in the Z-Wave network. After nodes are added to the network, the primary controller is responsible for determining communication routes to nodes, based on feedback from every node that the controller adds to the network. Additional nodes can be added at any time.

Other proposals have involved systems for paging waiters in a restaurant. The problem with these paging systems is that they do not utilize a flexible wireless communication system, such as Z-wave. Also, the table top transmitters are not elegant and easy to use. Even though the above cited systems for paging waiters in a restaurant meet some of the needs of the market, a system and method for paging and monitoring a server for paging a server in a service establishment through use of customer transmitter devices positioned on tables, service transmitter device positioned in a kitchen or service desk, and wearable server devices worn by servers; whereby all the devices are operatively connected through a Z-wave communication protocol is still desired.

### SUMMARY

Illustrative embodiments of the disclosure are generally directed to a system and method for paging and monitoring a server. The system for paging a server is operable in a service establishment; utilizing unique communication devices, such as customer transmitter devices that position on tables, service transmitter device that position in a kitchen or service desk, and wearable server devices worn by servers. The customer transmitter devices are defined by an elegant easy-to-use design that streamlines the process of paging a server. The server has a wearable server device, defined by an organic light-emitting diode (OLED) display screen that displays the paging signals in order of received sequence.

In one embodiment, multiple customer transmitter devices position on tables, and responds to tactile engagement from customers. Tapping, for example, initiates transmission of customer paging signals to a wearable server device worn by a server. The customer transmitter device has an elegant design and is easy to operate for technically challenged customers. Further, a service transmission device in a service area of the establishment enables staff to page the server in the same manner. The wearable server device includes an OLED display screen that displays the paging signals in sequential order of receiving them. A Z-wave network ties the communication devices together in the service establishment. A processor communicates with a position tracker and a timer integrated in the wearable receiver. The processor calculates time and location of the server in relation to customers, generating a corresponding server report.

In some embodiments, the system comprises a Z-wave network that includes a hub controller; an Internet Wi-Fi transceiver; and multiple signal repeaters operatively disposed across a service establishment.

In other embodiments, the system also comprises multiple customer transmitter devices that are paired to the Z-wave network. The customer transmitter devices comprise a contact surface that is operable to detect tactile engagement. The customer transmitter devices is configured to transmit a customer paging signal in response to the tactile engagement. The customer paging signal travels across the Z-wave network between the signal repeaters. The contact surface of the customer transmitter devices is configured to illuminate in response to the tactile engagement. In this manner, the illumination indicates that the customer paging signal has been transmitted.

In other embodiments, the system also comprises one or more service transmitter devices that are paired to the Z-wave network. The service transmitter devices comprise a contact surface that is configured to detect tactile engagement. The service transmitter devices are also configured to transmit a service paging signal in response to the tactile engagement. The service paging signal travels across the Z-wave network between the signal repeaters. The contact surface of the service transmitter devices is configured to illuminate in response to the tactile engagement. In this manner, the illumination indicates that the service paging signal has been transmitted.

In other embodiments, the system also comprises one or more wearable server devices that are operatively connected to the customer transmitter devices and the service transmitter devices through the Z-wave network. The wearable server devices comprise a receiver that is configured to receive the customer paging signal and the service paging signal. The wearable server devices also comprise a vibrating apparatus that is configured to generate a vibration upon receiving the customer paging signal and the service paging signal. The wearable server devices also comprise a display screen. In some embodiments, display screen is an organic light-emitting diode display screen. The display screen is configured to display the identity of the customer transmitter devices that transmit the customer paging signal. The display screen is also configured to display the identity of the service transmitter devices that transmit the service paging signal. Additionally, the one or more wearable server devices further comprising a timer apparatus and a position tracking apparatus.

In other embodiments, the system also comprises a processor that is operatively connected to the wearable server devices. The processor is configured to calculate a proximate position of the wearable server devices in relation to the customer transmitter devices. The processor is also configured to calculate the duration of the proximate position of the wearable server devices in relation to the customer transmitter devices.

In another aspect, the Z-wave network comprises a mesh network defined by low-energy radio waves.

In another aspect, the system utilizes a mesh network that includes at least one following: a Z-wave network, a Zigbee network, a packet radio network, a thread network, an Smesh network, a SolarMESH project network, and a WiBACK wireless technology network.

In another aspect, the hub controller includes at least one of the following: a computer, a tablet, a laptop, and a smart phone.

In another aspect, the signal repeaters are operatively disposed between tables and across walls in the service establishment.

In another aspect, the service establishment includes at least one of the following: a restaurant, a hotel, a cruise ship, a nursing home, and an airplane.

In another aspect, the customer transmitter devices and the service transmitter devices are defined by a saucer shape, the saucer shape having a thickness of between 1/2 inch to 1 inch, and a diameter of up to about 5 inches.

In another aspect, the saucer shape is defined by a silver-colored or a platinum-colored perimeter edge.

In another aspect, the customer transmitter devices are operable on multiple tables in the service establishment, whereby each table has a corresponding customer transmitter device.

In another aspect, the service transmitter devices are operable in a kitchen or a service desk in the service establishment.

In another aspect, illumination by the contact surfaces of the customer transmitter devices and the service transmitter devices include at least one of the following: a color, a color pattern, and a sequence of colors.

In another aspect, the tactile engagement includes tapping the contact surfaces of the customer transmitter devices and the service transmitter devices.

In another aspect, the wearable server devices are operable to be worn on the wrist of a server.

In another aspect, the organic light-emitting diode display screen of the wearable server devices is operable to display the customer paging signal from the customer transmitter devices in a sequential order of transmission.

In another aspect, the processor generates a server report based on the proximate position and duration of the wearable server devices in relation to the customer transmitter devices.

In another aspect, the server report is configured to indicate the amount of time each wearable server device is proximal to the customer transmitter devices, and the amount of time each wearable server device is distal from the customer transmitter devices.

In another aspect, the processor generates the server report based on the proximate position and duration of the wearable server devices in relation to the service transmitter devices.

One objective of the present invention is to facilitate the process of calling a waiter to a table in a restaurant.

Another objective is to provide an elegant customer transmission device on each table top of the restaurant.

Another objective is to recharge the customer transmitter wirelessly, and allow the charge to last multiple days before requiring recharging.

Yet another objective is to design the customer transmission device to be easy-to-use, such as by tapping the screen to call the waiter, and causing the screen to illuminate in order to indicate that the waiter has been called.

Additional objectives are to provide an easy-to-use paging system for the elderly.

An exemplary objective is to position the signal repeaters strategically around a restaurant, so as to optimize the Z-wave network.

Additional objectives are to provide a strong signal, even with walls, barriers, tables, and different rooms inside the service establishment.

Yet another objective is to allow the kitchen to page the waiter, similar to the customers.

An exemplary objective is to monitor the performance of the waiter based on time spent with each customer, and time to reach a table after being paged.

Additional objectives are to reduce noise in the service establishment by only allowing the wearable server device to vibrate, and not make an audible sound to alert the server.

Yet another objective is to make the system portable over different types of service establishments, including: restaurants, cruise ships, hotels, and nursing homes.

Yet another objective is to provide an inexpensive to manufacture system for paging and monitoring a server.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary system for paging and monitoring a server inside of a restaurant, in accordance with an embodiment of the present invention;

FIG. 2 illustrates a block diagram of an exemplary Z-wave network, in accordance with an embodiment of the present invention;

FIG. 3 illustrates a top view of another exemplary system for paging and monitoring a server inside of a restaurant, showing the schematics of the relay switches, customer transmitter devices, and hub controller in relation to each other, in accordance with an embodiment of the present invention;

FIGS. 4A-4B illustrate perspective views of an exemplary customer transmitter devices, where FIG. 4A shows the customer transmitter device before being tapped by the customer, and FIG. 4B shows the customer transmitter devices illuminated to indicate tapping by the customer, and relay of the customer pager signal, in accordance with an embodiment of the present invention;

FIG. 5 illustrates a wearable server device worn be a server, wherein the wearable server devices operatively connect to the customer transmitter devices and the service transmitter devices through the Z-wave network, in accordance with an embodiment of the present invention;

FIG. 6 illustrates a screenshot of an exemplary server report, based on the proximate position and duration of the wearable server devices in relation to the customer transmitter devices, in accordance with an embodiment of the present invention; and

FIG. 7 illustrates a block diagram depicting an exemplary client/server system which may be used by an exemplary web-enabled/networked embodiment, in accordance with an embodiment of the present invention.

Like reference numerals refer to like parts throughout the various views of the drawings.

### DETAILED DESCRIPTION OF THE INVENTION

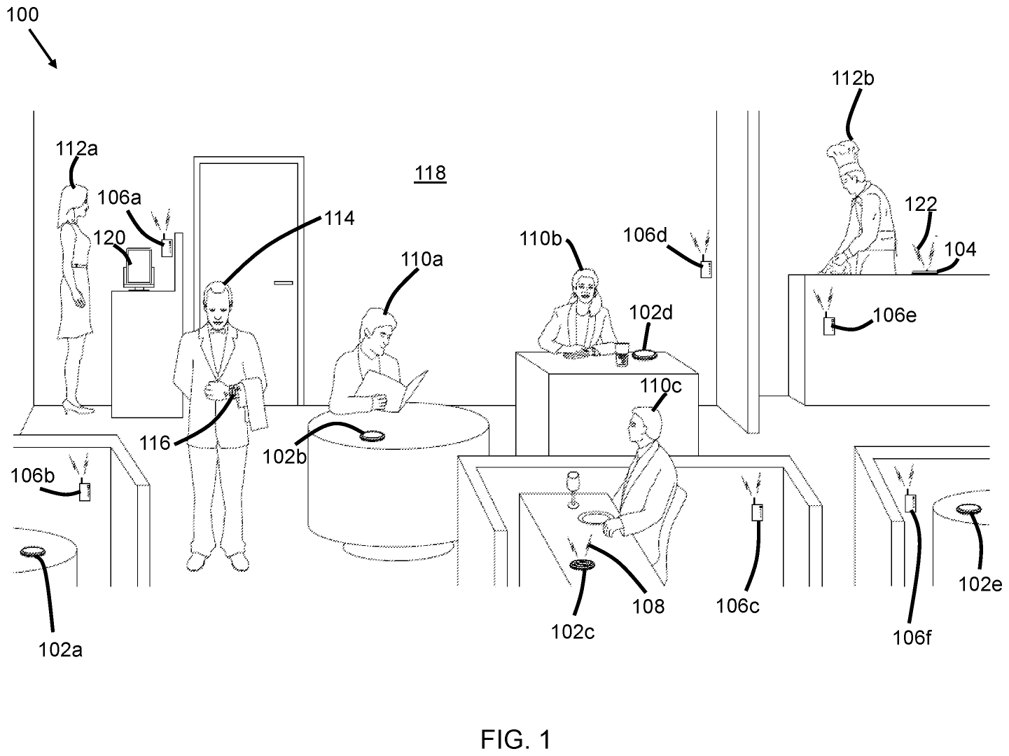

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method for paging and monitoring a server is referenced in FIGS. 1-7. The system 100 for paging and monitoring a server, hereafter “system 100”, is operable in a service establishment, or places where serves are often needed to assist customers and patrons 110a-c thereof. Looking initially at FIG. 1, the service establishment 118 may include, without limitation, a restaurant, a hotel, a cruise ship, a nursing home, and an airplane. The system 100 is unique in combining multiple communication devices in a unique paging and monitoring system 100.

The communication devices include: customer transmitter devices 102a-e that position on tables, rooms, and other customer-based locations; service transmitter device 104 that position in a kitchen or service desk where staff are generally located; and wearable server devices 116 worn by servers 114 who roam the service establishment 118 between customers 110a-c and service stations/kitchens. The customer transmitter devices 102a-e are defined by an elegant easy-to-use design that streamlines the process of paging a server 114. When activated by simple patting motion, each transmitter device illuminates and generates a paging signal unique to its table.

The wearable server device 116, which is worn by the server 114, comprises an organic light-emitting diode (OLED) display screen that displays the paging signals in order of received sequence. The Z-wave network 250 ties the communication devices together in the service establishment 118. A processor communicates with a position tracker and a timer integrated in the wearable receiver. The processor calculates time and location of the server in relation to customers 110a-c, generating a corresponding server report.

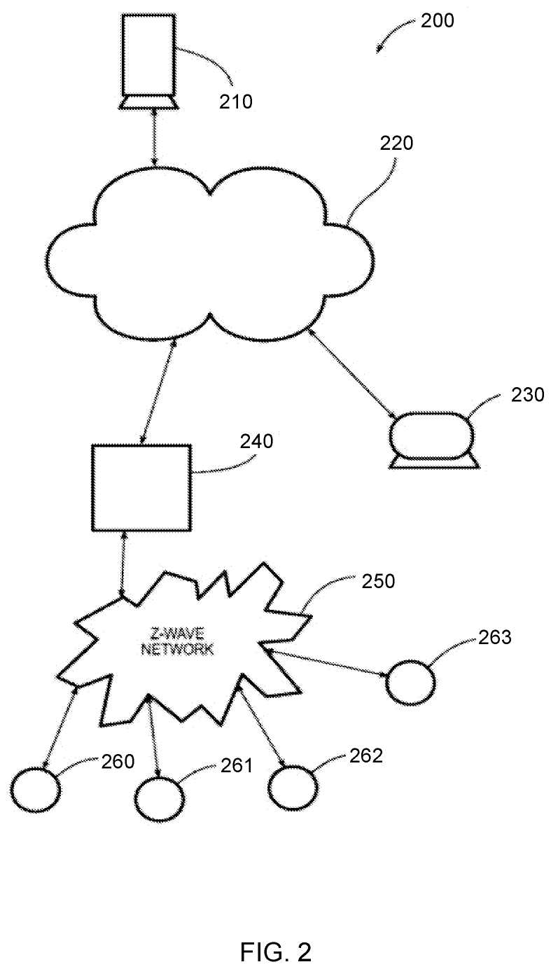

As referenced in FIG. 2, the system 100 comprises a Z-wave wireless communication protocol, forming a Z-wave network 250. The Z-wave network 250 enables communications in the service establishment 118. It is known in the art that the Z-wave network 250 comprises a mesh network defined by low-energy radio waves. In some embodiments, the Z-wave network 250 includes a hub controller 104. The comprises of a mesh network of low-energy radio waves to communicate between signal repeaters 106a-f, i.e., relay points, across the service establishment 118.

The Z-wave network 250 can be controlled via the Internet with intercommunication between multiple relay points positioned throughout the service establishment. An algorithm, which is operable in a hub controller 104, acts to regulate communications between the customer transmitter device and the wearable server device. However, in other embodiments, the system 100 may utilize different types of mesh networks, including, without limitation, a Zigbee network, a packet radio network, a thread network, an Smash network, a SolarMESH project network, and a WiBACK wireless technology network.

In some embodiments, the hub controller 104 may include, without limitation, a computer, a tablet, a laptop, and a smart phone. The Z-wave network 250 may also include an

Internet Wi-Fi transceiver. The Z-wave network 250 may also include multiple signal repeaters 106a-f that are operatively disposed across the service establishment. In other embodiments, the signal repeaters 106a-f are operatively disposed between tables and across walls in the service establishment 118.

Those skilled in the art will recognize that the numerous walls, floors, rooms, and staff in a service establishment 118 require a mesh network to optimize communications between customers, servers, and staff in which infrastructure nodes, i.e., bridges, switches, and other infrastructure devices, connect directly, dynamically and non-hierarchically. One exemplary mesh network is shown in a schematic diagram of an internetworking system 200 (FIG. 2). The internetworking system 200 includes Internet 220 and Z-wave network 250. As illustrated, a number of devices are in communication with each other over Internet 220, including a portal server 210, a user device 230 and a Z-wave networking device 240. User device 230 may communicate with portal server 210 through a web browser interface, using standard hypertext transfer protocol (HTTP).

In one embodiment of the internetworking system 200, a portal server 210 communicates with Z-wave networking device 140 through lower layer Internet protocols, such as Transmission Control Protocol/Internet Protocol (TCP/IP) or User Datagram Protocol/Internet Protocol (UDP/IP). Z-wave networking device 240 conducts radio frequency (RF) communications with Z-wave networking devices 260-263. It should be noted that some devices 260-263 may be in direct communication with Z-wave networking device 240. As Z-wave network 250 is a mesh network, some devices 260-263 may communicate with Z-wave networking device 240 indirectly, through other devices 260-263.

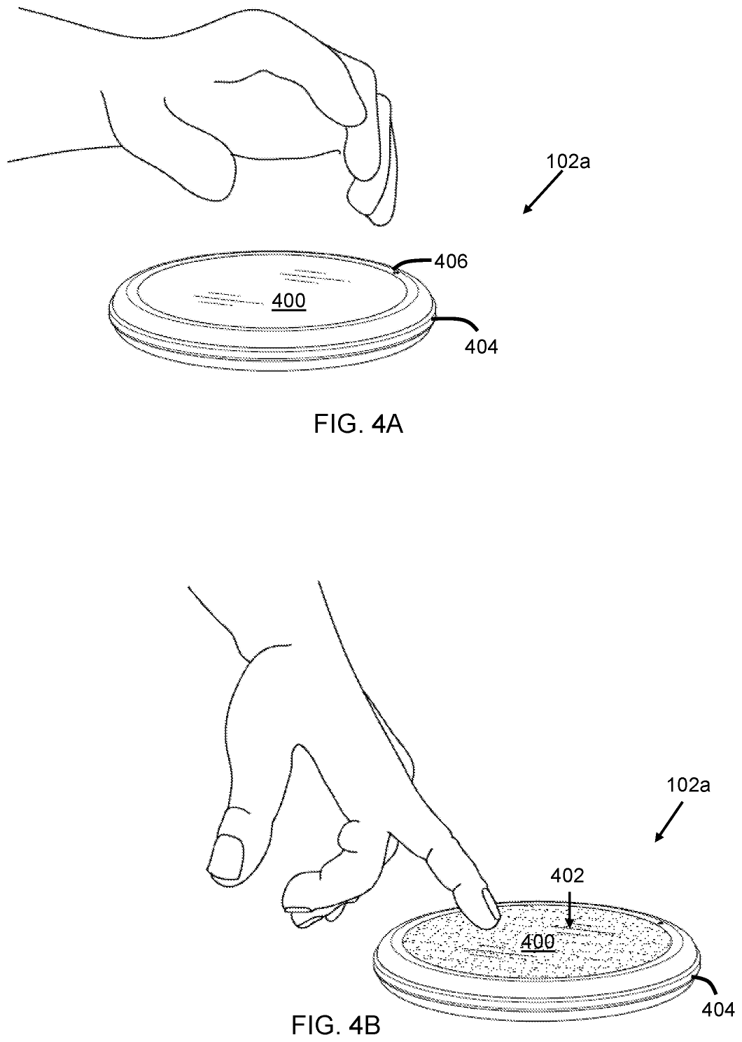

Looking again at FIG. 1, the system 100 also comprises multiple customer transmitter devices 102a-e that are paired to the Z-wave network 250. In some embodiments, the customer transmitter devices 102a-e are defined by a saucer shape, the saucer shape having a thickness of between ½inch to 1 inch, and a diameter of up to about 5 inches. In one non-limiting embodiment, the saucer shape is defined by a silver-colored or a platinum-colored perimeter edge 404, shown in FIG. 4A. Further, in one possible embodiment, the customer transmitter devices 102a-e has no ports for wires to plug into for charging or data exchange. However, the customer transmitter devices 102a-e includes a rechargeable battery 406 that can be charged wirelessly, such as on a charging pad. Notably, the charge lasts for longer than a few days.

In one embodiment, multiple customer transmitter devices 102a-e position on tables, and responds to tactile engagement from customers 110a-c. Tapping, for example, initiates transmission of customer paging signals 108 to a wearable server device worn by a server. The customer transmitter device has an elegant design and is easy to operate for technically challenged customers.

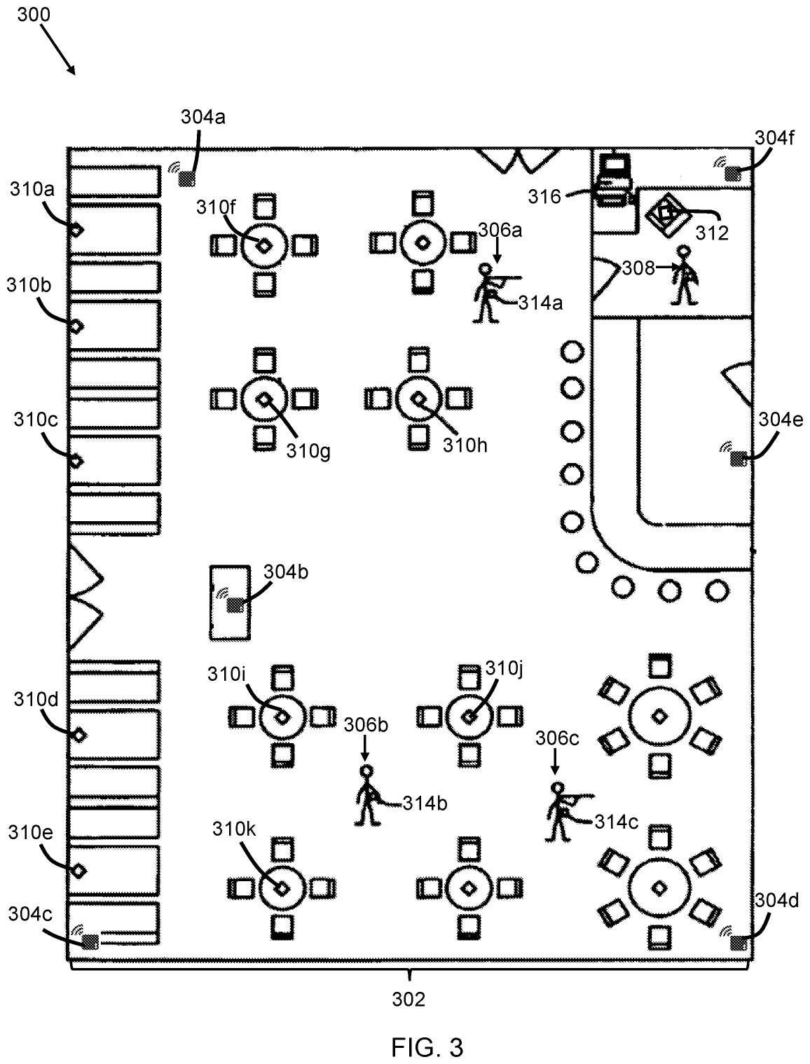

FIG. 3 illustrates a top view of the system 100 inside of a restaurant 302, showing the schematics of the signal repeaters, customer transmitter devices, and hub controller in relation to each other. The devices operate in the realm of a Z-wave network 300 that is strategically installed in the restaurant 302. As illustrated, multiple signal repeaters 304a-f, or infrastructure nodes, are operatively mounted across walls, rooms, ceilings, and kiosks. For example, signal repeater 304f is installed in the kitchen, and signal repeater 304b is installed at a host welcome kiosk. The signal repeaters 304a-f carry pager signals between customers, servers 306a-c, and service employees 308, i.e., chef, expediter, hostess.

In one alternative embodiment, the signal repeaters 304a-f are at least partially embedded inside the walls of the service establishment. This embedded configuration increases the surfaces for which the customer pager signals 108 to bounce around the service establishment, and is an effective relay means for a mesh network, such as used by Z-wave network.

Continuing with FIG. 3, multiple customer transmitter devices 310a-k are operable on tabletops that the customers sit during dining. The customer transmitter devices 310a-k are configured in an elegant, easy to use configuration to assist the customer in paging the server assigned to that table. Further, a service transmitter device 312 is in the kitchen, so that the service employees 308, i.e., chef, hostess, can easily page the server through a simple tapping motion on the surface of the service transmitter device 312. The servers 306a-c don wearable server devices 314a-c that alerts to the paging table or kitchen, and the sequence of paging. A hub controller 316 regulates communications between the customer transmitter devices 310a-k and the wearable server device 314a-c.

Looking again at FIG. 4A, an exemplary customer transmitter devices 102acomprises a contact surface 400 that is operable to detect tactile engagement from the hand of the customer 110a. In one non-limiting embodiment, the tactile engagement includes tapping the contact surfaces of the customer transmitter devices 102a-e. The customer transmitter devices 102a-e is configured to transmit a customer paging signal 108 in response to the tactile engagement. In some embodiments, the customer transmitter devices 102a-e are operable on multiple tables in the service establishment, whereby each table has a corresponding customer transmitter device (See FIGS. 1 and 3). The customer paging signal 108 travels across the Z-wave network 250 between the signal repeaters 106a-f. The contact surface 400 of the customer transmitter devices 102a-e is configured to illuminate in response to the tactile engagement.

As illustrated in FIG. 4B, an illumination 402, which is visible on the contact surface 400, indicates that the customer paging signal 108 has been transmitted. In one embodiment, the illumination is a predetermined color or color pattern to indicate to the customer that the signal to the waiter has been sent to come to the table. In some embodiments, illumination 402 by the contact surfaces 400 of the customer transmitter devices 102a-e and the service transmitter devices 104 include: a color, a color pattern, and a sequence of colors. For example, the contact surface 400 lights a warm blue color after being patted by the customer. This provides a visual indication that the server has been paged. For example, FIG. 4A shows the customer transmitter device 102a before being tapped by the customer, and FIG. 4B shows the customer transmitter device 102a illuminated to indicate tapping by the customer, and relay of the customer pager signal.

In other embodiments, the system 100 also comprises one or more service transmitter devices 104 that are paired to the Z-wave network 250. The service transmission devices 104 operate in a service area of the establishment, so as to enable service staff 112a-b, management, and other servers to page the server in the same manner as the customer pages the server through the customer transmitter device. In some embodiments, the service transmitter devices 104 are operable in a kitchen or a service desk in the service establishment.

In some embodiments, the service transmitter devices 104 are defined by a saucer shape, the saucer shape having a thickness of between ½inch to 1 inch, and a diameter of up to about 5 inches. In one non-limiting embodiment, the saucer shape is defined by a silver-colored or a platinum-colored perimeter edge.

The service transmitter devices 104 comprise a contact surface that is configured to detect tactile engagement. In one non-limiting embodiment, the tactile engagement includes tapping the contact surfaces of the service transmitter devices 104. The service transmitter devices are also configured to transmit a service paging signal 122 in response to the tactile engagement. The service paging signal travels across the Z-wave network 250 between the signal repeaters 106a-f. The contact surface of the service transmitter devices is configured to illuminate in response to the tactile engagement. In this manner, the illumination indicates that the service paging signal 122 has been transmitted.

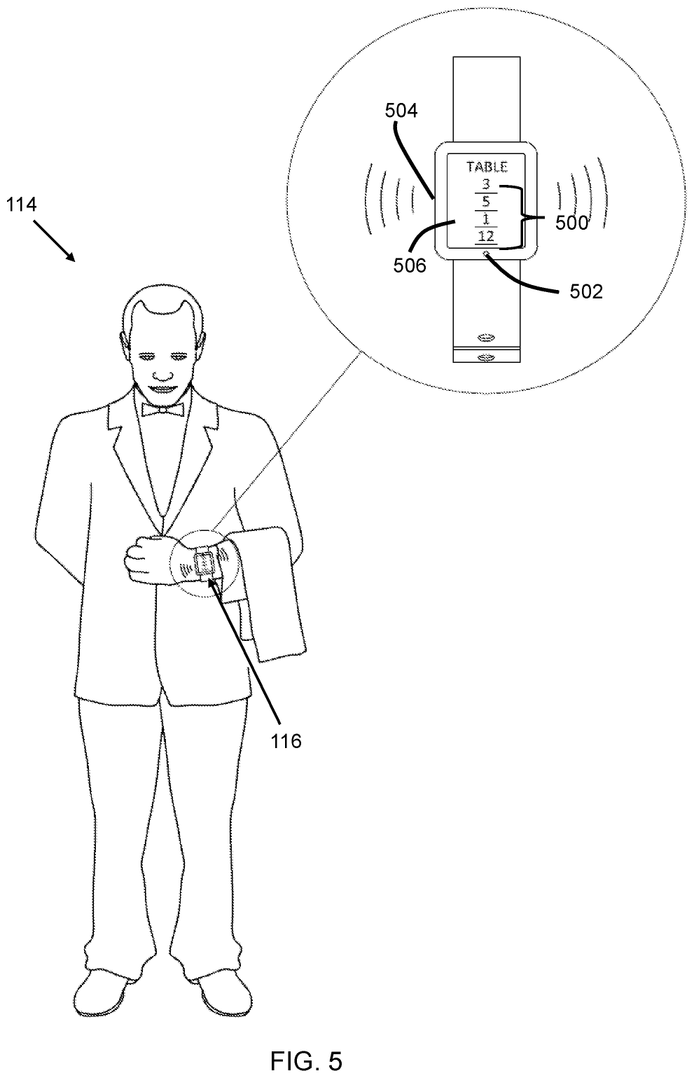

Looking now at FIG. 5, the system 100 also comprises one or more wearable server devices 116 worn be the server 114. The wearable server devices 116 are operatively connected to the customer transmitter devices 102a-e and the service transmitter devices through the Z-wave network 250. In some embodiments, the wearable server devices 116 are operable to be worn on the wrist of a server 114. For example, illustrated is the waiter wearing the wearable server device on the wrist, with a sequence of tables 500 being displayed directly on the display screen. The sequence of tables 500 is easily viewed in order of the paging by the customers at the server's respective tables. In this manner, the server 114 can attend to the customers that transmitted the paging signal in order of signaling.

In one possible embodiment, the wearable server devices 116 comprise a receiver 502 that is configured to receive the customer paging signal 108 and the service paging signal. The wearable server 116 devices also comprise a vibrating apparatus 504 that is configured to generate a vibration upon receiving the customer paging signal 108 and the service paging signal 116 that transmits across the Z-wave network 250. The use of vibrations negates unwanted noise from audible alerts , which can be advantageous in a fine dining restaurant, for example.

The wearable server device 116 also includes a display screen 506 that displays the paging signals in sequential order of receiving them. In some embodiments, the display screen 506 is an organic light-emitting diode (OLED) display screen. The OLED display screen of the wearable server devices 116 is operable to display the customer paging signal 108 from the customer transmitter devices 102a-e in a sequential order of transmission. The display screen 506 is also configured to display the identity of the service transmitter devices that transmit the service paging signal 122. Additionally, the one or more wearable server devices further comprising a timer apparatus and a position tracking apparatus.

In other embodiments, the system 100 also comprises a processor 120 that is operatively connected to the wearable server devices 116. The processor 120 is configured to calculate a proximate position of the wearable server devices in relation to the customer transmitter devices 102a-e. The processor 120 is also configured to calculate the duration of the proximate position of the wearable server devices in relation to the customer transmitter devices 102a-e.

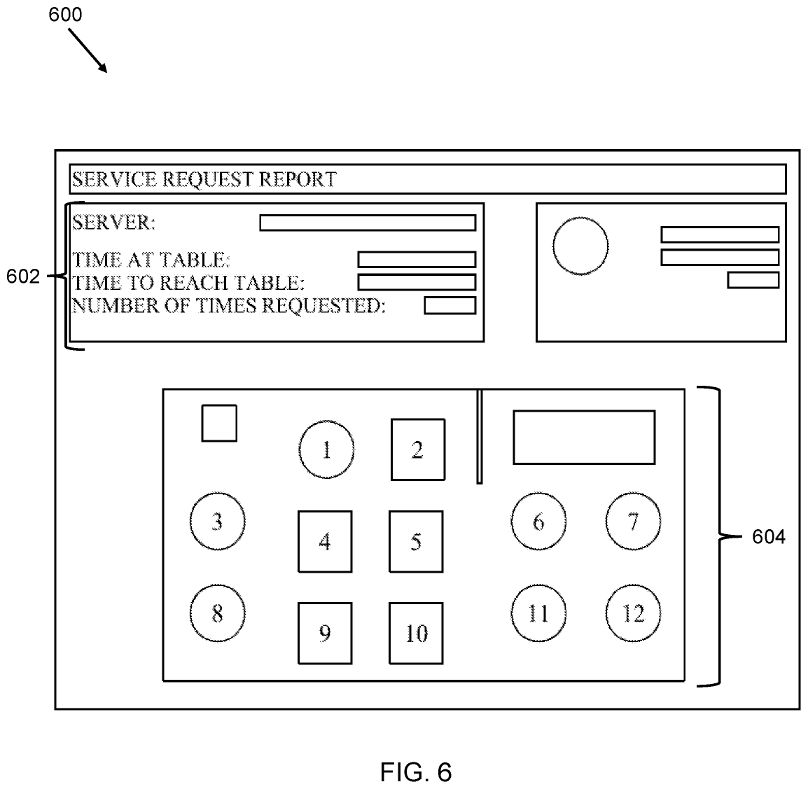

As FIG. 6 shows, the processor 120, by using the aforementioned server data, generates a server report 600 based on the proximate position and duration of the wearable server devices in relation to the customer transmitter devices 102a-e. The server report 600 is configured to indicate the amount of time each wearable server device 116 is proximal to the customer transmitter devices 102a-e, and the amount of time each wearable server device is distal from the customer transmitter devices 102a-e. In one exemplary use, the processor generates the server report 600 based on the proximate position and duration of the wearable server devices in relation to the service transmitter devices. A report portion 602 includes the name of the server, the amount of time the server spent on each table, the time to reach the table, and the time spent at the table. In some embodiments, a position graphic portion 604 shows the layout of the service establishment, and may include a real time view of the user,

In operation, the customer transmitter device 102a-e has an elegant saucer-shape with smooth lines, and a smooth contact surface that the customer can lightly tap to transmit a customer paging signal 108 to the signal to the wearable server devices, which are worn by the server. When engaged in such a manner, the customer transmitter device illuminates to indicate to the customer that the customer paging signal 108 has been sent to the server. The wearable server device 116 is wearable, and utilize an organic light-emitting diode (OLED) display screen, which displays a table number in sequential order of receiving the customer paging signal 108. Each wearable server device may be assigned a specific customer transmitter device, or table, so that the appropriate server is alerted that the customer requires service at the table.

For example, the customer can alert the waiter via the customer transmitter device on the tabletop that service is required. The waiter receives the alert, and the identity of the customer transmitter device (table number) on their personal wearable server device through a vibration, and proceeds to the requesting table.

The Z-wave wireless communication protocol comprises of a mesh network of low-energy radio waves to communicate between signal repeaters 106a-f, i.e., relay points, across the service establishment. The Z-wave network 250 can be controlled via the Internet with intercommunication between multiple relay points positioned throughout the service establishment. An algorithm, which is operable in a hub controller 104, acts to regulate communications between the customer transmitter device and the wearable server device. Similarly, a transmitter device communicates with the server's wearable server device to page the server to the service area, such as a kitchen or front desk.

For example, the chef can alert the waiter via the service transmitter device that the food order for a particular table is ready and waiting to be collected. The waiter receives the alert on their personal wearable server device through a vibration, and proceeds to the kitchen to collect the food order.

For monitoring the server, the system 100 provides a processor that is operatively connected to the wearable server devices and/or the customer transmitter devices through the Z-wave network. The processor is configured to access and process data generated by a timer apparatus and a position tracking apparatus integral in the wearable server devices. The processor can calculate a proximate position of the wearable server devices in relation to the customer transmitter devices. The processor is also operable to calculate the duration of the proximate position of the wearable server devices in relation to the customer transmitter devices. Thus, the location of the server, and duration of time the server is at each table or service area in the service establishment may be determined.

For example, the processor calculates the time that the waiter has been at a first table, and the time that a second table has requested service. A report is then generated indicating the duration that the waiter was waiting on the customer in the first table, and the duration that the customer in the second table had to wait for the waiter to arrive.

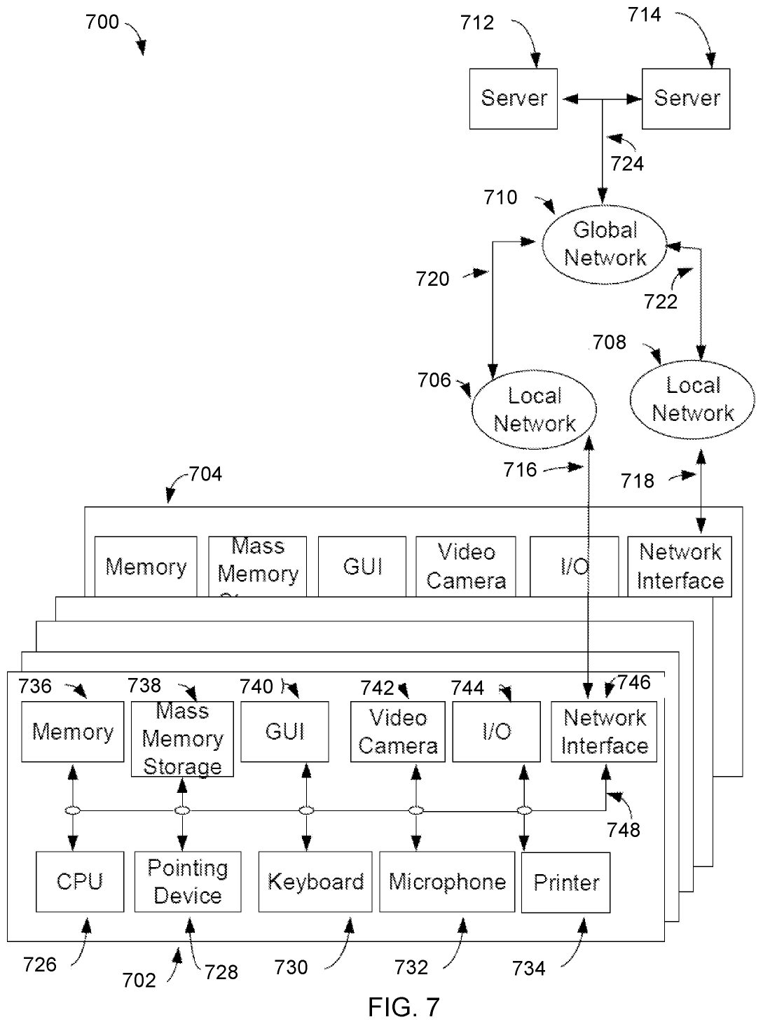

FIG. 7 is a block diagram depicting an exemplary client/server system which may be used by an exemplary web-enabled/networked embodiment of the present invention. A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones.

Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A system for paging and monitoring a server, the system comprising:
a mesh network including:
a hub controller;
an Internet Wi-Fi transceiver; and
multiple signal repeaters operatively disposed across a service establishment;
multiple customer transmitter devices paired to the mesh network, the customer transmitter devices comprising a contact surface operable to detect tactile engagement, the customer transmitter devices operable to transmit a customer paging signal in response to the tactile engagement, the customer paging signal traveling across the mesh network between the signal repeaters, the contact surface of the customer transmitter devices being operable to illuminate in response to the tactile engagement, whereby the illumination indicates that the customer paging signal has been transmitted; and
one or more wearable server devices operatively connected to the customer transmitter devices through the mesh network,
the wearable server devices comprising a receiver operable to receive the customer paging signal,
the wearable server devices further comprising a vibrating apparatus operable to generate a vibration upon receiving the customer paging signal,
the wearable server devices further comprising a display operable to display the customer paging signal from the customer transmitter devices in a sequential order of transmission.

2. The system of claim 1, further comprising one or more service transmitter devices paired to the mesh network, the service transmitter devices comprising a contact surface operable to detect tactile engagement, the service transmitter devices operable to transmit a service paging signal in response to the tactile engagement, the service paging signal traveling across the mesh network between the signal repeaters.

3. The system of claim 2, wherein the contact surface of the service transmitter devices is operable to illuminate in response to the tactile engagement, whereby the illumination indicates that the service paging signal has been transmitted.

4. The system of claim 2, wherein the one or more wearable server devices are operatively connected to the service transmitter devices through the mesh network.

5. The system of claim 2, wherein the receiver of the wearable server devices is operable to receive the service paging signal.

6. The system of claim 1, wherein the one or more wearable server devices comprise a timer apparatus and a position tracking apparatus.

7. The system of claim 6, further comprising a processor operatively connected to the timer apparatus and the position tracking apparatus of the wearable server devices.

8. The system of claim 7, wherein the processor is operable to calculate a proximate position of the wearable server devices in relation to the customer transmitter devices, the processor further being operable to calculate the duration of the proximate position of the wearable server devices in relation to the customer transmitter devices.

9. The system of claim 8, wherein the processor is operable to generate a server report, the server report showing the amount of time each wearable server device is proximal to the customer transmitter devices, and the amount of time each wearable server device is distal from the customer transmitter devices.

10. The system of claim 1, wherein the hub controller includes at least one of the following: a computer, a tablet, a laptop, and a smart phone.

11. The system of claim 1, wherein the signal repeaters are operatively disposed between tables and across walls in the service establishment.

12. The system of claim 1, wherein the customer transmitter devices are defined by a saucer shape, the customer transmitter devices having a thickness of between ½inch to 1 inch, and a diameter of up to about 5 inches, the customer transmitter devices comprising a silver-colored or a platinum-colored perimeter edge.

13. The system of claim 1, wherein the customer transmitter devices are operable on multiple tables in the service establishment, whereby each table has a unique customer transmitter device.

14. The system of claim 1, wherein the contact surface of the customer transmitter devices illuminate to form at least one of the following: a color, a color pattern, and a sequence of colors.

15. The system of claim 1, wherein the display screen of the wearable server devices comprises an organic light-emitting diode display screen.

16. The system of claim 1, wherein the display screen of the wearable server devices is operable to display the customer paging signal from the customer transmitter devices in a sequential order of transmission.

17. The system of claim 1, wherein the mesh network includes at least one following: a Z-wave network, a Zigbee network, a packet radio network, a thread network, an Smash network, a SolarMESH project network, and a WiBACK wireless technology network.

18. A system for paging and monitoring a server, the system comprising:
a Z-wave network including:
a hub controller;
an Internet Wi-Fi transceiver; and
multiple signal repeaters operatively disposed across a service establishment, at least one of the signal repeaters being embedded in the walls of the service establishemnt;
multiple customer transmitter devices paired to the Z-wave network, the customer transmitter devices comprising a contact surface operable to detect tactile engagement, the customer transmitter devices operable to transmit a customer paging signal in response to the tactile engagement, the customer paging signal traveling across the Z-wave network between the signal repeaters, the contact surface of the customer transmitter devices being operable to illuminate in response to the tactile engagement, whereby the illumination indicates that the customer paging signal has been transmitted,
the customer transmitter devices being defined by a saucer shape, the customer transmitter devices comprising a colored perimeter edge;
a rechargeable battery operable to power the customer transmitter devices, the rechargeable battery being wirelessly chargeable;
one or more service transmitter devices paired to the Z-wave network, the service transmitter devices comprising a contact surface operable to detect tactile engagement, the service transmitter devices operable to transmit a service paging signal in response to the tactile engagement, the service paging signal traveling across the Z-wave network between the signal repeaters, the contact surface of the service transmitter devices being operable to illuminate in response to the tactile engagement, whereby the illumination indicates that the service paging signal has been transmitted;
one or more wearable server devices operatively connected to the customer transmitter devices and the service transmitter devices through the Z-wave network,
the wearable server devices comprising a receiver operable to receive the customer paging signal and the service paging signal, the wearable server devices further comprising a vibrating apparatus operable to generate a vibration upon receiving the customer paging signal and the service paging signal,
the wearable server devices further comprising an organic light-emitting diode display screen operable to display the customer paging signal from the customer transmitter devices in a sequential order of transmission,
the organic light-emitting diode display screen further being operable to display the identity of the service transmitter devices that transmit the service paging signal,
the one or more wearable server devices further comprising a timer apparatus and a position tracking apparatus; and
a processor operatively connected to the timer apparatus and the position tracking apparatus of the wearable server devices, the processor operable to calculate a proximate position of the wearable server devices in relation to the customer transmitter devices, the processor further being operable to calculate the duration of the proximate position of the wearable server devices in relation to the service transmitter devices.

19. The system of claim 18, wherein the processor is operable to generate a server report, the server report showing the amount of time each wearable server device is proximal to the customer transmitter devices, and the amount of time each wearable server device is distal from the customer transmitter devices.

20. A system for paging and monitoring a server, the system consisting of:
a Z-wave network including:
a hub controller;
an Internet Wi-Fi transceiver; and
multiple signal repeaters operatively disposed across a service establishment;
multiple customer transmitter devices paired to the Z-wave network, the customer transmitter devices comprising a contact surface operable to detect tactile engagement, the customer transmitter devices operable to transmit a customer paging signal in response to the tactile engagement, the customer paging signal traveling across the Z-wave network between the signal repeaters, the contact surface of the customer transmitter devices being operable to illuminate in response to the tactile engagement, whereby the illumination indicates that the customer paging signal has been transmitted,
the customer transmitter devices are defined by a saucer shape, the customer transmitter devices having a thickness of between ½inch to 1 inch, and a diameter of up to about 5inches, the customer transmitter devices comprising a silver-colored or a platinum-colored perimeter edge; one or more service transmitter devices paired to the Z-wave network, the service transmitter devices comprising a contact surface operable to detect tactile engagement, the service transmitter devices operable to transmit a service paging signal in response to the tactile engagement, the service paging signal traveling across the Z-wave network between the signal repeaters, the contact surface of the service transmitter devices being operable to illuminate in response to the tactile engagement, whereby the illumination indicates that the service paging signal has been transmitted; one or more wearable server devices operatively connected to the customer transmitter devices and the service transmitter devices through the Z-wave network, the wearable server devices comprising a receiver operable to receive the customer paging signal and the service paging signal,
the wearable server devices further comprising a vibrating apparatus operable to generate a vibration upon receiving the customer paging signal and the service paging signal, the wearable server devices further comprising an organic light-emitting diode display screen operable to display the customer paging signal from the customer transmitter devices in a sequential order of transmission,
the organic light-emitting diode display screen further being operable to display the identity of the service transmitter devices that transmit the service paging signal,
the one or more wearable server devices further comprising a timer apparatus and a position tracking apparatus; and
a processor operatively connected to the timer apparatus and the position tracking apparatus of the wearable server devices, the processor operable to calculate a proximate position of the wearable server devices in relation to the customer transmitter devices, the processor further being operable to calculate the duration of the proximate position of the wearable server devices in relation to the service transmitter devices,
the processor being operable to generate a server report, the server report showing the amount of time each wearable server device is proximal to the customer transmitter devices, and the amount of time each wearable server device is distal from the customer transmitter devices.
